(19) United States
(12) Patent Application Publication
(10) Pub. No.: US 2025/0345147 A1
(43) Pub. Date: Nov. 13, 2025

(54) DENTAL SURGICAL GUIDE FIXATION DEVICE

(71) Applicant: M3 HEALTH INDÚSTRIA E COMÉRCIO DE PRODUTOS MÉDICOS, ODONTOLÓGICOS E CORRELATOS S.A., Jundiai (BR)

(72) Inventors: Alex ARAÚJO NUCINI, Santa Rosa de Viterbo (BR); Samy TUNCHEL, São Paulo (BR); Alberto BLAY, Pacaembu (BR)

(21) Appl. No.: 18/854,271

(22) PCT Filed: Apr. 4, 2023
(86) PCT No.: PCT/BR2023/050111

§ 371 Date: Oct. 4, 2024

(30) Foreign Application Priority Data
Apr. 5, 2022 (BR) 1020220065730

(51) Int. Cl. A61C 1/08

(52) U.S. Cl. CPC A61C 1/084

(57) ABSTRACT

The invention refers to a dental guide fixator for guided surgical procedures fixed in an internal region of at least one implant comprising: —a fixed pin being inserted using a key or manually with an apical region comprising a fixation thread region comprising an adjustment thread and a regulating element comprising an internal thread configured to be threaded to the adjustment thread and having a guide fixation region; the regulating element is threaded onto the fixed pin being passed through a hole in a surgical guide and fixed to the internal thread of a dental implant through the fixation thread in the apical region, whereby the guide fixation region comes into contact with the guide and said regulating element is threaded onto the fixed pin in order to compress the guide between the guide fixation region and the surface of the patient's mouth.

### FIELD OF THE INVENTION

The present invention belongs to the technological sector of Dentistry and refers to a dental guide fixator for guided surgical procedures.

### FUNDAMENTALS OF THE INVENTION

In the field of dental surgeries, guided surgery is a minimally invasive method, with a detailed planning of the patient's bone structure and the angulations of the implants, in order to make a rigid surgical guide, made for just that surgery. With the advancement of computer modeling of complex shapes, it is possible for the professional to perform graphic simulations of implant placement for the manufacture of surgical stencils.

In this reality, the surgical guide is an important tool for the correct positioning of the fixations, aiming at a perfect prosthetic-surgical interrelationship. The reproduction of the teeth of the patient's future prosthesis, by means of a removable appliance that adapts perfectly to the surgical area, has become a fundamental prerequisite for future prosthetic success.

For a guide to adequately perform its functions, it needs to be adapted to the surgical region, without interfering with the surgeon's visualization and access. Also, one of the factors that guarantee accuracy in drilling and implant installation is the good stability of the surgical guide in the patient's mouth, the more stable the guide, the less movement it can undergo, guaranteeing precision.

In this sense, some solutions have already been proposed in the state of the art.

Document BR 102017020486 3 discloses a surgical guide for drilling implants in which an anchoring pin is inserted into the anchorage hole, and the guide is fixed directly to the patient's gums in an angular manner. However, this type of fixation is invasive and can cause trauma in the region, requiring additional perforations.

Also, document BR 112018076928-2 reveals an individual guide in which the professional must hold the guide while marking the holes.

These widespread solutions in the state of the art have important applications, but have an invasive fixation, in which the gingival bone is traumatized so that the guide is anchored.

An alternative way of fixing an operative guide is to take advantage of the primary and/or secondary stability of a first dental implant to insert a fixation pin that serves as an anchor for the surgical guide.

Documents US20160287336 and US20150265372 disclose threaded pins that take advantage of the presence of a dental implant to be threaded to said implant in order to temporarily fix the surgical guide to provide stability. A possible problem with these solutions is that the stability of the guide depends on a precise height of the fixation pin. This height, in turn, depends on the depth that the implant into which the pin is threaded was implanted. In common scenarios it is easy to imagine that different implants have different depths and types of anchorage.

In this way, this implant would have to be implanted with the intention of being used for the fixation of a guide, or different fixation pins must be manufactured foreseeing different clinical cases.

To solve these problems, the present invention conceives a fixation pin for surgical guides, to be installed in an internal thread of an implant, having height adjustment means for contact with the guide, in order to compensate for the different infraosseous depths of the implants, corresponding to different clinical cases.

Therefore, there is no state-of-the-art solution equivalent to the one presented here in the present invention that combines, with an inventive construction, technical differentials, practicality and quality.

### OBJECTIVES OF THE INVENTION

Thus, it is an object of the present invention to provide a solution to the above-listed challenges and limitations by presenting a dental guide fixator for guided surgical procedures.

It is an object of the present invention to provide a guide fixator that attaches to the internal thread of a dental implant.

It is also an objective of the present invention to provide a unique surgical guide fixator that adapts to different implant sizes and depths, keeping the guide at a constant desired height.

It is a further object of the present invention to provide a fixator that is easy to handle during the surgical procedure.

It is a further object of the present invention to provide a reliable secure fixator.

It is a further object of the present invention to provide a compatible fixator with sterilization processes.

### SUMMARY OF THE INVENTION

The present invention achieves these and other objectives by means of a dental surgical guide fixation device, fixed in an internal region of at least one implant comprising:
a fixed pin;
the apical region of the fixed pin comprising a threaded region of fixation;
the fixed pin further comprising an adjustment thread;
the fixed pin can be inserted with the aid of a key or manually;
   wherein the apical region of the body of the fixed pin has a diameter substantially smaller than the rest of said fixed pin, in order to allow the apical region to be fixed to the internal region of a dental implant;
a regulating element;
regulating element comprising an internal thread configured to be threaded to the fixed pin's regulating thread; and
said regulating element further comprising a guide attachment region;
   Wherein the regulator being configured so as to be threaded onto the fixed pin, said fixed pin passed through a hole in a surgical guide and fixed to the internal thread of a dental implant through the fixation thread present in the apical region in order to create a point of support, whereby the guide fixation region comes into contact with the guide and said regulating element is threaded onto the fixed pin in order to compress the guide between the guide fixation region and the surface of the patient's tooth.

### BRIEF DESCRIPTION OF THE DRAWINGS

The present invention will be described based on the attached drawings, which illustrate:

FIG. 1 illustrates the exploded view in perspective of the guide fixator in a preferred embodiment of the present invention.

FIG. 2 illustrates the perspective view of the guide fixator assembled in a preferred embodiment of the present invention.

FIG. 3 illustrates the front view of the guide fixator in a preferred embodiment of the present invention.

FIG. 4 illustrates the side view of the guide fixator in a preferred embodiment of the present invention.

FIG. 5 illustrates the schematic view of the height adjustment of the guide support using the fixator, for different clinical cases of implants.

### DETAILED DESCRIPTION OF THE INVENTION

The present invention relates to a dental guide fixator for guided surgical procedures. The present invention has an innovative height adjustment system, to achieve high stability, resistance, and fixation security, compensating for different levels of infraosseous depth of the implants used in the fixation of the guide.

The present invention presents numerous technical and economic advantages when compared to the state of the art, some of which are listed below:
The present invention features a two-piece construction, with a single, strong pin and a height adjuster;
The present invention offers greater stability, as it allows the fixation of the guide in multiple internal implants, ensuring that the height is constant;
The present invention makes it possible to manufacture a single model, compatible with multiple clinical cases, while the state of the art is limited to the need to produce different sizes and models of fixators for the suitability of cases;
The present invention presents safety and reliability because it is made of surgical material;
The present invention is easy to use because it allows the fixed pin to be installed manually or with the aid of a tool.

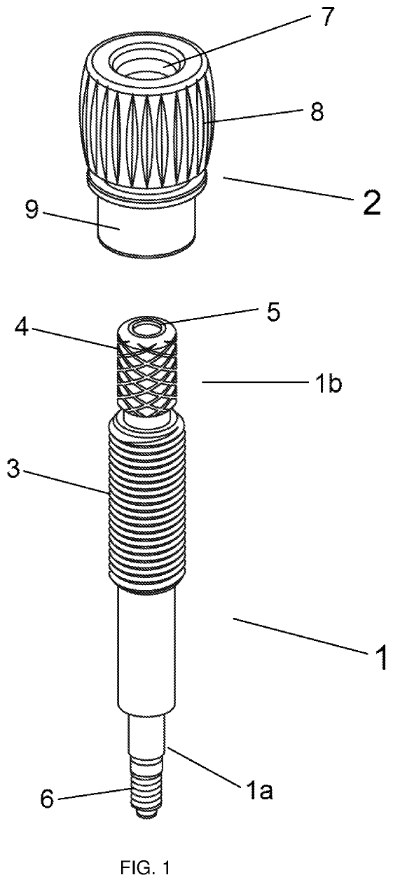

The present invention comprises a fixed pin 01. Referring to FIG. 1, the fixed pin 01 comprises a fixation thread region 06 in its apical region 01a and an adjustment thread 03 in the central region.

In a preferred embodiment of the present invention, the fixed pin further comprises a grooved surface 04 in the coronal region 01b and a key connector 05.

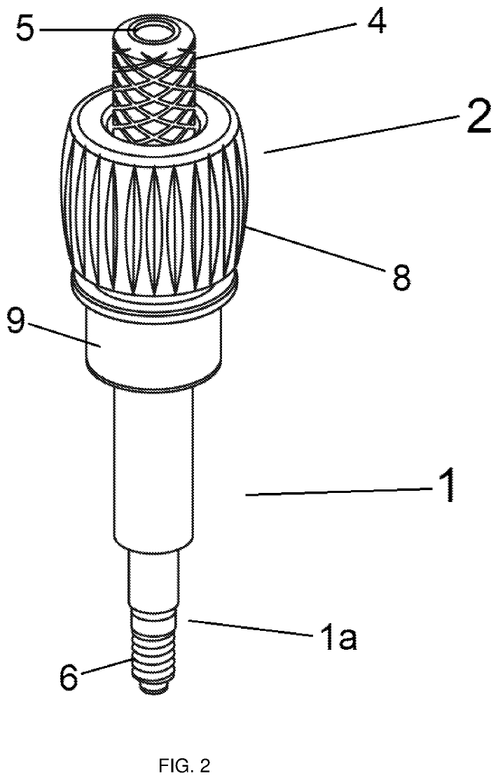

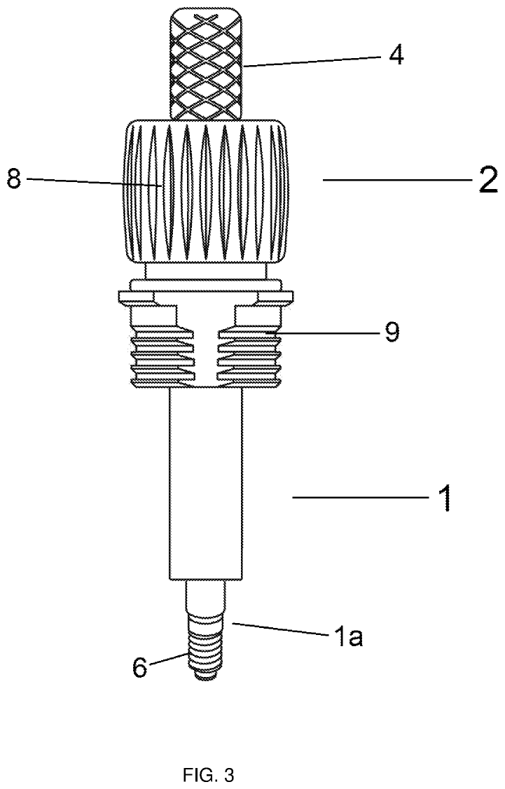

Additionally, the apical region 01a of the body of the fixed pin 01 has a diameter substantially smaller than the rest of said fixed pin 01, in order to allow the apical region 01a to be fixed to the internal region of a dental implant as referenced in FIGS. 2 and 3.

The present invention further comprises a regulating element 02. The regulating element 02 comprises an internal thread 07 configured so as to be threaded to the regulating thread 03 of the fixed pin 01.

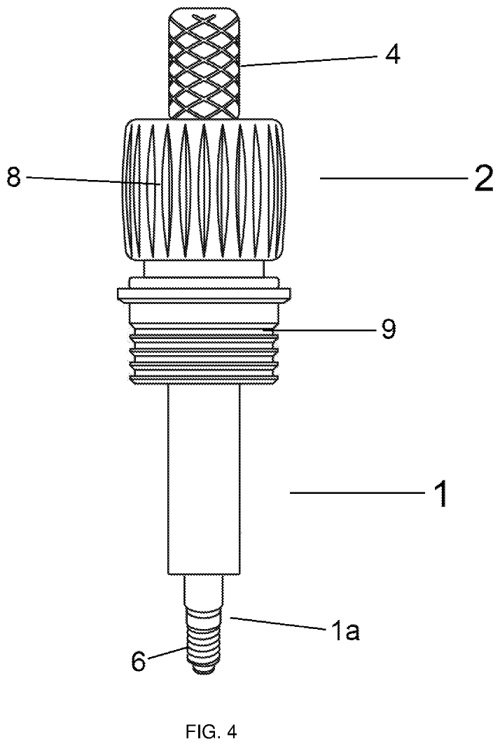

With reference to FIGS. 3 and 4, the regulating element 02 also comprises a handling region 08 equipped with grooves and a guide fixation region 09.

The diameter of the regulating element 02 can vary from 3.0 to 8.0 mm depending on the diameter of the washer hole in the guide.

The guide fixation region 09 can be equipped with fixation means to receive the surgical guide, such as a thread, chamfered thread, or fitting.

Additionally, both the fixed pin 01 and the regulator 02 are made of material suitable for surgical procedures, preferably surgical stainless steel or titanium.

### Device Operation

With reference to FIG. 2, regulator 02 is configured to be threaded onto fixed pin 01.

The surgical guide must be prepared in such a way as to comprise a hole coincident with the fixation point (implant).

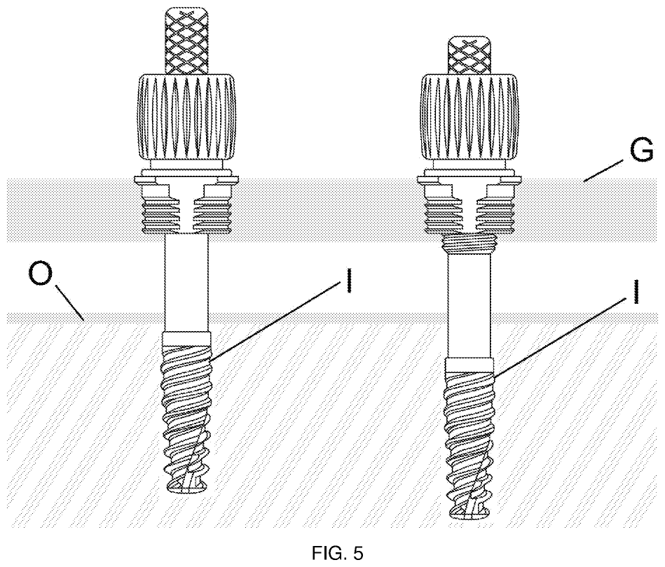

As shown in FIG. 5, the fixed pin 01 is passed through the guide hole and is fixed to the internal thread of a dental implant (I) anchored in bone tissue (O). The fixed pin is fixed to said implant (I) through the fixation thread 06 present in the apical region 01a.

Additionally, the fixation of the fixed pin 01 to the implant can be done by rotating the fixed pin 01 manually, handling it by the grooved surface 04 or with the aid of a torquemeter or similar tool, through the wrench connector 05.

With pin 01 installed, a firm ‘pillar’ is created. The regulating element 02 is threaded onto the fixed pin 01 manually, through the handling region 08.

Further, according to FIG. 5, as the regulating element 02 is tightened, the surgical guide (G) is compressed between the guide fixation region 09 and the oral surface of the patient. The regulating element 02 is rotated to a position where there is no gap between the guide and the surface of the patient's dental arch, where the guide (G) is to be fixed.

As a result, regardless of the infraosseous depth of the implant and its position, the regulator 02 ensures that the guide (G) is always fixed without play, applying a slight force against the guide towards the patient's dental arch, so that different types of fixators are not required, as illustrated in FIG. 05.

Having described some examples of preferred embodiments of the present invention, it should be understood that the scope of the present invention covers other possible variations of the described inventive concept, being limited only by the content of the claims only, including the possible equivalents.

1. Dental surgical guide fixation device, fixed in an internal region of at least one implant characterized by comprising:
a fixed pin;
the apical region of the fixed pin comprising a fixation thread region;
the fixed pin further comprising an adjustment thread; whereby the apical region of the body of the fixed pin has a substantially smaller diameter than the rest of said fixed pin, in order to allow the apical region to be fixed to the internal region of an implant dental;
a regulating element;
regulating element comprising an internal thread configured so as to be threaded to the regulating thread of the fixed pin;
said regulating element further comprising a guide fixation region the regulator being configured so as to be threaded onto the fixed pin, said fixed pin being passed through a hole in a surgical guide and fixed to the internal thread of a dental implant through the fixation thread present in the apical region in order to create a support point, and the guide fixation region comes into contact with the guide and said regulating element is threaded on the fixed pin in order to compress the guide between the guide fixation region and the surface of the patient's mouth.

2. Fixation device according to claim 1, characterized by the fixed pin further comprising a grooved surface in the coronal region and/or a key connector.

3. Fixation device according to claim 1, characterized by the regulating element additionally comprising a handling region provided with ridges.

4. Fixation device according to claim 1, characterized by the guide fixation region being provided with fixation means to receive the surgical guide, said fixation means being one of: thread, chamfered thread and fitting by interference.

5. Fixation device according to claim 1, characterized by both the fixed pin and the regulator being made of surgical stainless steel or titanium.

6. Fixation device according to claim 1, characterized by both the fixed pin and the regulator being fixed using a key or manually.
